(19) United States
(12) Patent Application Publication
(10) Pub. No.: US 2013/0283901 A1
(43) Pub. Date: Oct. 31, 2013

(54) ENGINE TEST BENCH

(71) Applicant: AVL LIST GMBH, GRAZ (AT)

(72) Inventors: Gerhard MAIER, WAGERSBACH (AT); Wilhelm GREYLINGER, MUERZZUSCHLAG (AT); Rene KOEGL, WEINBURG (AT)

(21) Appl. No.: 13/865,327

(22) Filed: Apr. 18, 2013

(30) Foreign Application Priority Data
Apr. 18, 2012 (AT) A 50137/2012

(51) Int. Cl. G01M 15/04

(52) U.S. Cl. CPC G01M 15/04
USPC 73/116.02

(57) ABSTRACT

An engine test stand with a single-cylinder internal combustion test engine, having a crankcase accommodating a crankshaft, on which a cylinder housing is exchangeably placed with a cylinder which receives a reciprocating piston. The engine test stand includes and comprising at least one mass-balancing device which is driven by the crankshaft. In order to simplify the reconfiguration of the engine test stand for different engine variants, it is provided that the mass-balancing device is integrated in a base frame fixed to the test stand, with the crankcase being rigidly connected to the base frame.

### CROSS-REFERENCE TO RELATED APPLICATIONS

The present application claims priority to Austrian Patent Application No. A 50137/2012 (filed on Apr. 18, 2012), which is hereby incorporated by reference in its entirety.

### TECHNICAL FIELD

The invention relates to an engine test stand with a single-cylinder internal combustion test engine, especially a single-cylinder two-stroke crosshead internal combustion engine, comprising a crankcase accommodating a crankshaft, on which a cylinder housing is exchangeably placed with a cylinder for receiving a reciprocating piston, and comprising at least one mass-balancing device which is driven by the crankshaft.

### BACKGROUND

A single-cylinder test engine with an exchangeable cylinder block and cylinder head placed on the crankcase is known from AT 263 454 B. The crankcase is substantially maintained when reconfiguring the test engine. Said single-cylinder test engine is designed for the development of rapidly running internal combustion engines, but it is not suitable for the development of large two-stroke crosshead engines, e.g. with bores of between 350 and 1000 mm and piston travels of between 1500 mm and 3500 mm.

The reconfiguration to another engine variant is a very difficult and time-consuming task in conventional test setups for single-cylinder engines of large size because it is necessary to exchange either the complete engine and/or all setup components.

### SUMMARY

It is the object of the invention to avoid these disadvantages and to simplify the reconfiguration to another engine variant in the case of slow-running single-cylinder two-stroke crosshead internal combustion engines.

This is achieved in accordance with the invention in such a way that the mass-balancing device is integrated in a base frame fixed to the test stand, with the crankcase being rigidly connected to the base frame.

The base frame with the mass-balancing device is a fixed component of the engine stand and comprises several mass-balancing shafts, preferably two mass-balancing shafts of the first order and two mass-balancing shafts of the second order, which can be driven via a gear drive, preferably a toothed gearing or a belt-and-chain drive, by the crankshaft.

The crankcase consists of a bottom part and an upper part, with the bottom part of the crankcase being connected to the base frame. The upper part of the crankcase is detachably attached to the bottom part of the crankcase.

The internal combustion test engine comprises a crosshead which is displaceably mounted in the cylinder housing. The crosshead is movably connected to the crankshaft via a connecting rod on the one hand and via a piston rod to the piston reciprocating in the cylinder on the other hand. It is advantageous in this respect if the cylinder is formed by an exchangeable liner.

The crankshaft is connected via a drive shaft to a flywheel and a braking device, wherein an external outside bearing of the engine test stand for the drive shaft can be arranged between the flywheel and the braking device. The braking device is preferably arranged as a hydraulic brake in order to absorb the high powers of the internal combustion test engine.

It is especially advantageous if the crankshaft is connected to an electrical machine, preferably a starting or dragging motor. The electrical machine allows dragging the internal combustion engine or bringing the same to a starting speed. A braking torque for the internal combustion test engine can also be applied via the electrical machine.

A relevant improvement is obtained in the reconfiguration of the engine test stand in such a way that the engine test stand has a universally applicable basic setup and comprises at least one variable engine module. The basic setup is maintained for all possible engine variants in an unchanged manner and the engine modules can be exchanged flexibly depending on the engine variant. As a result, it is no longer necessary to exchange all components of the engine test stand when switching from one engine variant to another one. Consequently, reconfiguration times and costs can be reduced to a substantial extent.

It is especially advantageous if the basic setup comprises the components of base frames, mass-balancing shafts, bottom part of the crankcase, upper part of the crankcase, flywheel, braking device and electrical machine, and preferably also a transfer gear between crankshaft and mass-balancing device for driving the mass-balancing shafts. A large part of the engine test stand therefore need not be changed during reconfiguration.

High flexibility for various engine variants is obtained nevertheless when at least one engine module comprises at least one of the components of the cylinder housing, cylinder, crankshaft, connecting rod, crosshead, piston rod and piston.

In order to enable the fulfilment of the demands placed on mass balancing in different engine sizes, it is provided within the scope of the invention that at least one exchangeable and/or variable balancing mass can respectively be arranged on the mass-balancing shafts. The balancing masses can be adjusted to the requirements of the respective engine.

In order to take the different loads and requirements of lubricating points into account, it is advantageous if the engine test stand comprises several lubricating oil circuits, with preferably at least two lubricating oil circuits being arranged separate from one another.

It can be provided that a first lubricating oil circuit is provided for the lubricating oil supply of the bearing points of the crankshaft, the connecting rod, the mass-balancing shafts and the transfer gear, a second lubricating oil circuit for the lubricating oil supply of the crosshead, and a third lubricating oil circuit for the lubrication of the piston.

### DRAWINGS

The invention will be explained below in closer detail by reference to the drawings, which schematically show as follows:

FIG. 1 illustrates the engine test stand in a sectional view along the line I-I in FIG. 2.

FIG. 2 illustrates the engine test stand in a sectional view along the line II-II in FIG. 1.

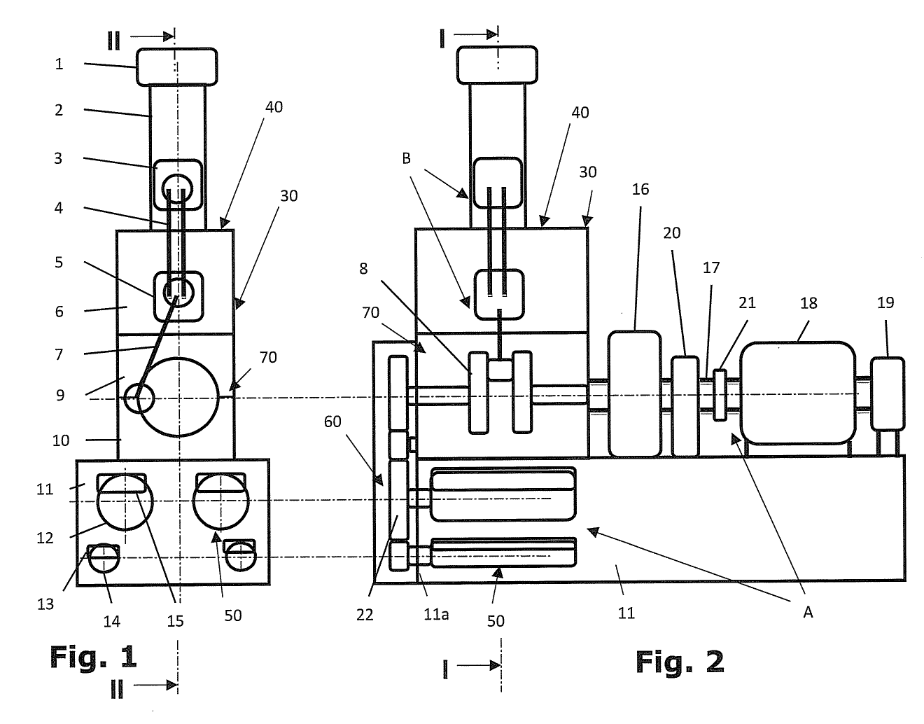

### DESCRIPTION

The test setup of the engine test stand 30 for a single-cylinder internal combustion test engine 40 principally comprises the components of the basic setup A, which components remain on the engine test stand 30 and are configured that they are suitable for various engine sizes. These components include the base frame 11 with the mass-balancing device 50, the crankcase 70 with the bottom part 10 and the upper part 9 of the crankcase, the flywheel 16, the outside bearing 20, drive shaft 17, coupling 21, braking device 18 and the electrical machine 19 which acts as a starting and/or dragging motor.

The test setup further comprises at least one engine module B with the engine-specific components of the cylinder cover 1, the cylinder 2, the piston 3, the piston rod 4, the crosshead 5, the cylinder housing 6, the connecting rod 7, and the crankshaft 8. The components of the engine module B of the single-cylinder internal combustion test engine 40 are always respectively adjusted to the new engine size.

A mass-balancing device 50 of first and second order is integrated in the base frame 11. The mass-balancing weights 13, 15 which are fixed to the mass-balancing shafts 12, 14 of first and second order are respectively adjusted to the requirements of the various engine sizes. A transfer gear 60 for the mass-balancing shafts 12, 14 are arranged in the front region 11a of the base frame 11, wherein the transfer gear 60 can be formed by a toothed gearing 22. A belt-and-chain drive can be used as an alternative to the toothed gearing 22. The drive of the mass-balancing shafts 12, 14 can occur from the crankshaft 8 via the toothed gearing 22 or via a chain drive in the case of engines with very large lifts of stroke.

The bottom part 10 and the upper part 9 of the crankcase are positioned on the base frame 11, with the crankshaft 8 being arranged horizontally in the bottom part 10 of the crankcase. The main bearing of the crankcase 8 is adjusted to the largest possible engine variant, and therefore the upper and bottom part 9, 10 of the crankcase can be used without any changes for every engine variant. The crankshaft 8 is rotatably connected to the drive shaft 17 of the basic setup A. A flywheel 16 is fixed to the drive shaft 17 in the longitudinal direction of the crankshaft 8, which flywheel can be used without any changes for all possible engine sizes. The outside bearing 20 is connected downstream of the flywheel 16, which bearing supports the drive shaft 17 and can always remain in the base frame 11. A shaft coupling 21 is arranged between the outside bearing 20 and the braking device 18, which shaft coupling is dimensioned in such a way that it covers the requirements of the entire range of applications and therefore can be used in an unchanged manner for all possible test engine sizes in the intended range.

The braking device 18, which is fixed to the base frame 11 and which is advantageously arranged as a hydraulic brake, is used for approaching defined engine load points and also remains on the base frame 11. In order to enable starting of the engine despite the braking device 18, an electrical machine 19 is provided with which the single-cylinder internal combustion test engine 40 can be started. Similarly, the electrical machine 19 can be used for dragging the single-cylinder internal combustion test engine 40. The test engine will be brought to a defined speed without engine combustion in dragging operations in order to enable measurements to be performed. Furthermore, the electrical machine 19 can also be used as a supporting dynamometric brake.

The components of the engine module B are adjusted to the engine size to be operated after each change of an engine variant and therefore usually need to be separated from the basic setup A and changed following a change of the engine. Although the crankshaft 8 always has the same diameter of the main bearing, the crankpin fillet and crankpin diameter of the crankshaft 8 are predetermined by the respective test engine. Piston travels of between 1500 mm and 3500 mm can be realised with the described engine test stand. In order to enable the implementation of this bandwidth of piston travels, a respective cylinder housing 6 will respectively be used in each change. The crosshead 5 of the single-cylinder test combustion engine 40 will be accommodated in the cylinder housing 6.

The use of three different lubricating oil circuits is principally possible, which can respectively have different pressure levels. A first lubricating oil circuit is used for lubricating the bearing points of the crankshaft 8, the connecting rod 7, the mass-balancing shafts 12, 14 and the transfer gear 60. A second lubricating oil circuit is used for supplying lubricating oil to the crosshead 5, in which a different pressure level is often desired. A third lubricating oil circuit can be used for the lubrication of the piston 3, which is preferably arranged separate from the first and the second lubricating oil circuit.

A flexible test basis can be created with the described engine test stand for the purpose of developing and testing single-cylinder internal combustion test engines 40 of different sizes, especially two-stroke crosshead engines.

1-18. (canceled)

19. An engine test stand for a single-cylinder internal combustion test engine having a crankcase accommodating a crankshaft, on which a cylinder housing is exchangeably placed with a cylinder which receives a reciprocating piston, the engine test stand comprising:
a test stand:
base frame fixed to the test stand, wherein the crankcase is rigidly connected to the base frame; and
at least one mass-balancing device configured to be driven by the crankshaft and integrated in the base frame.

20. The engine test stand of claim 19, wherein the mass-balancing device comprises:
first mass-balancing shafts rotatably mounted in the base frame; and
second mass-balancing shafts which are rotatably mounted in the base frame,
wherein the second mass-balancing shafts are different that the first mass-balancing shafts.

21. The engine test stand of claim 19, wherein:
the crankcase has a bottom part and an upper part which form main bearings for the crankshaft;
the upper part of the crankcase is detachably connected to the bottom part of the crankcase; and
the base frame is rigidly connected to a bottom part of the crankcase.

22. The engine test stand of claim 19, further comprising a crosshead displaceably mounted in the cylinder housing.

23. The engine test stand of claim 19, wherein the cylinder is formed by an exchangeable liner.

24. The engine test stand of claim 19, further comprising a flywheel connected in a torsion-proof manner to the crankshaft.

25. The engine test stand of claim 19, wherein the crankshaft is connected to a braking device via at least one shaft coupling.

26. The engine test stand of claim 25, wherein the braking device is comprises a hydraulic brake.

27. The engine test stand of claim 19, wherein the crankshaft is connected to an electrical machine.

28. An engine test stand comprising:
a basic setup configured for use with an internal combustion test engine; and
at least one variable engine module.

29. The engine test stand of claim 28, wherein the basic setup comprises:
a base frame configured for rigid connection to a crankcase of the internal combustion engine;
a mass-balancing device configured to be driven by the crankshaft and integrated in the base frame, the mass-balancing device having first mass-balancing shafts rotatably mounted in the base frame, and second mass-balancing shafts which are rotatably mounted in the base frame;
a bottom part and an upper part of the crankcase which form main bearings for a crankshaft of the internal combustion engine, wherein the upper part of the crankcase is detachably connected to the bottom part of the crankcase, and the base frame is rigidly connected to a bottom part of the crankcase;
a flywheel connected in a torsion-proof manner to the crankshaft;
a braking device connected to the crankshaft;
an electrical machine connected to the crankshaft; and
a transfer gear configured to drive the mass-balancing device.

30. The engine test stand of claim 29, wherein the at least one engine module comprises:
a cylinder housing with a cylinder which receives a reciprocating piston;
the crankshaft;
a connecting rod; and
a crosshead;
a piston rod.

31. The engine test stand of claim 30, wherein at least one exchangeable and/or variable balancing weight is respectively arranged on the mass-balancing device.

32. The engine test stand of claim 30, further comprising a plurality of lubricating fluid circuits, with at least two of the lubricating fluid circuits being arranged separate from one another.

33. The engine test stand of claim 32, wherein a first lubricating fluid circuit is configured to supply lubricating fluid to bearing points of the crankshaft, the connecting rod, the mass-balancing device and the transfer gear.

34. The engine test stand of claim 33, wherein a second lubricating fluid circuit is configured to supply lubricating fluid to the crosshead.

35. The engine test stand of claim 34, wherein a third lubricating fluid circuit is configured to supply lubricating fluid to the piston.

36. The engine test stand of claim 35, wherein at least two of the lubricating fluid circuits have different pressure levels.

37. An engine test stand for an internal combustion engine having a crankcase accommodating a crankshaft, on which a cylinder housing is placed with a cylinder which receives a reciprocating piston, the engine test stand comprising:
a test stand:
base frame connected to the crankcase; and
a mass-balancing device configured to be driven by the crankshaft and integrated in the base frame, wherein the mass-balancing device includes first mass-balancing shafts rotatably mounted in the base frame, and second mass-balancing shafts which are rotatably mounted in the base frame.
